(19) United States
(12) Patent Application Publication
(10) Pub. No.: US 2005/0099812 A1
(43) Pub. Date: May 12, 2005

(54) Conduction state indicating connector

(76) Inventor: Chang-Chi Lee, Yun-Lin Shian (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/704,616

(22) Filed: Nov. 12, 2003

(51) Int. Cl. F21V 33/00

(52) U.S. Cl. 362/253; 362/800; 362/226

(57) ABSTRACT

A conduction state indicating connector for power furnished connector plugs such as DVI, HDMI, USB, SCART, IEEE394, and RJ-type connectors in which the outer housing of the connector is a transparent entity having an LED or other luminescent component circuited inside. When the connector is in a state of conduction, light from the luminescent component is emitted through the transparent outer housing and the entire connector is illuminated, the light rays facilitating the insertion of such connectors in dark areas, while also enhancing appearance and enabling the unique function of extended promotional appeal.

### BACKGROUND OF THE INVENTION

1) Field of the Invention

The invention herein relates to connector devices, specifically a conduction state indicating connector capable of displaying conduction status as well as character patterns.

2) Description of the Prior Art

Given the widespread growth of computers around the world and the rapid development of global international computer networking, an immense transformation in human survival is occurring such that computers have become an indispensable aspect of daily life and work, resulting in the rising importance of computer peripheral connectivity. To accommodate the different requirements of computer and peripherals interfacing, people have invented USB (Universal Serial Bus), IEEE (Institute of Electric Electronic Engineer) 1394, RJ (Ethernet), DVI (Digital Visual Interface), HDMI (High Definition Multimedia Interface), and other connectors, with such connectors providing for rapid and, furthermore, efficient equipment interconnection, effectively solving the problem of transferring audio-video frequency signals and data signals between different equipment.

As is well-known, after the said types of connectors are inserted into female sockets, since the female sockets lack a status indicating function, the users of the said equipment are unable to effectively identify whether the said connectors are in a normal operative connected state, which is especially crucial during equipment malfunctioning because the user cannot effectively eliminate the possibility that the connector is the problem. Additionally, such connectors are often installed at equipment back surfaces, an area where light intensity is relatively low, and since the connector has no indicator light for confirming a conduction enabled configuration, the user faces positioning difficulty when plugging and unplugging the said types of connectors.

### SUMMARY OF THE INVENTION

The invention herein addresses the shortcomings of existing connectors by providing a conduction state indicating connector that in addition to providing an indication of conduction and whether the light source is illuminating, also displays a character pattern pre-positioned on the connector outer housing and has an innovative status indication approach, the light rays of which facilitate insertion in relatively dark areas.

The essential principles of the invention herein are: the transmission circuits of the various connector types listed in the present invention have four to ten wires, wherein two or more wires handle the transmission of various signals and two wires handle the forwarding of power. Such connectors transmit signals and at the same time carry low voltage electrical current and handle the forwarding of the said electrical current, with the electrical current supplied utilized for switching on and maintaining peripheral equipment operation; the electrical current can also be coupled to a luminescent component, enabling the luminescent component to emit light and thereby indicate connector conduction status.

The conduction state indicating connector of the invention herein is comprised of a connector, the features of which are: the entire connector outer housing is a transparent entity (can be assembled or completely injection molded) and an LED or other luminescent component is disposed inside; when the connector is in the conduction state, light from the luminescent component is emitted through the transparent outer housing such that the entire connector is illuminated.

The conduction state indicating connector of the invention herein is comprised of a connector, the features of which are: the said connector housing is a transparent entity, a luminescent component is disposed inside the connector, and the said luminescent component is coupled to power supply wires inside the connector, with a character pattern inverse decal is affixed onto the surface of its outer housing; when the electric wiring cable is in conduction, in addition to illuminating the entire connector, the character pattern inverse decal is simultaneously highlighted by the illumination.

The conduction state indicating connector of the invention herein is comprised of a connector, the features of which are: the said connector housing is a non-transparent entity, a luminescent component is disposed inside the connector, and the said luminescent component is coupled to power supply wires inside the connector, with a character pattern formed into the surface of the said housing serving as a pellucid construct such that the light of the said luminescent component is emitted outward through the character pattern.

The said connector is a USB plug, an IEEE1394 plug, an RJ plug, a DVI plug, an HDMI plug, or a SCART plug.

A resistor of an appropriate size can be placed in series between the said power lead and the said luminescent component to adjust the magnitude of current supplied to the said luminescent component.

The character pattern on the connector outer housing can be a trademark or another graphic design, or USB and IEEE1394 label.

### BRIEF DESCRIPTION OF THE DRAWINGS

FIG. 1 is an isometric drawing of the connector embodiment of the invention herein.

FIG. 2 is an exploded drawing of the connector embodiment of the invention herein.

FIG. 3 is an isometric drawing of the connector invention herein utilizing a completely transparent outer housing, with a character pattern inverse decal on the embodiment.

FIG. 4 is an isometric drawing of the connector invention herein utilizing a non-transparent outer housing, with a pellucid character pattern showing on the surface of the said outer housing.

### DETAILED DESCRIPTION OF THE INVENTION

The invention herein utilizes power furnished connectors such as USB, IEEE1394 6-core, DVI, HDMI, SCART, and RJ plugs, wherein the electricity-bearing power line leads to an LED or other luminescent component installed at the end and the entire connector outer housing is a transparent entity such that after the said connector is inserted into a female socket, if situated in a signal and power conduction ready mode, light rays are refracted through the outer housing, indicating that the connector is in a state of conduction.

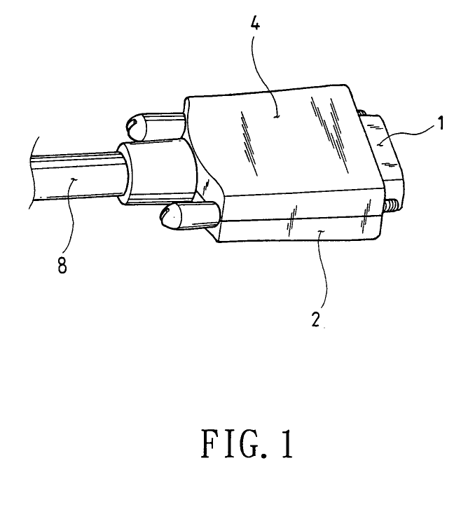

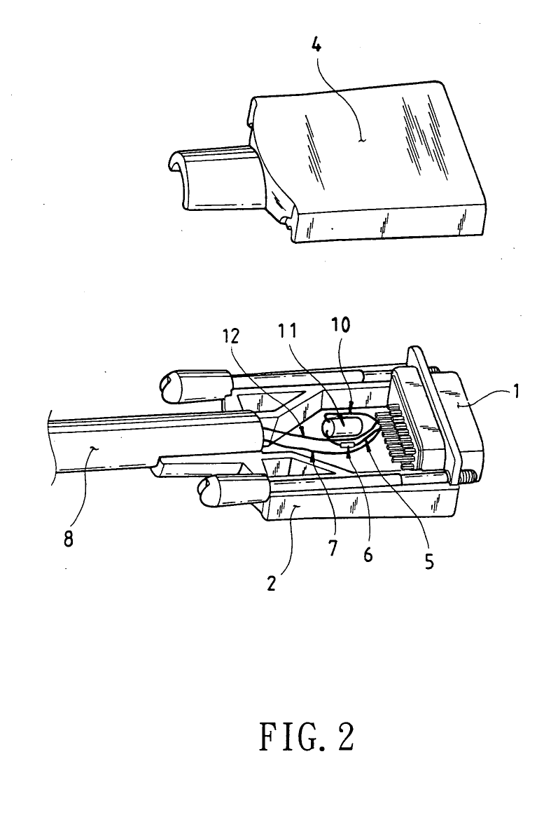

Referring to FIG. 1 and FIG. 2, the isometric and exploded drawings of the connector embodiment of the invention herein as utilized in a DVI connector, the connector plug 1 at the connector lower housing 2 and the rear extent of the contact pins inside the connector upper housing 4 are coupled to the power wires 7 and 12 of a cable 8 via the contact pin power leads 5 and 10 of the connector plug 1, with a luminescent component 11 installed at the end. When the said connector is in a conduction ready state, the luminescent component 11 glows and since its light rays shine outward through the transparent connector upper housing 4 and the connector lower housing 2, the user determines that the connector is already in a conduction ready state.

The said structure of the invention herein, in addition to utilization on the upper and lower housing of an assembly-type connector, can also be utilized in an one-piece injection molded connector fabrication method and, furthermore, a resistor 6 of an appropriate size can be placed into the said power lead 5 to adjust the supplied current if so required.

Due to the structural principles of the invention herein, the entire connector can be fabricated as a transparent member and a character pattern inverse decal 3 affixed onto the corresponding area of the LED luminescent component 11; when the connector area is in the conduction state, in addition to the entire connector glowing, the character pattern is at the same time illuminated, thereby enhancing its appearance and enabling the unique function of extended promotional appeal.

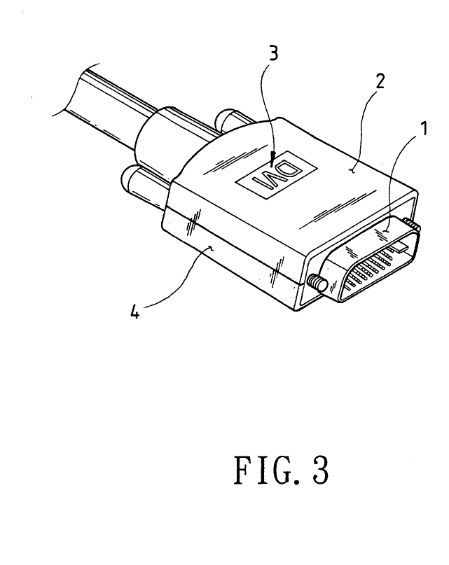

As indicated in FIG. 3, the entire plug is fabricated as a transparent connector upper housing 4 and connector lower housing 2, with a character pattern inverse decal 3 affixed onto the corresponding area of the LED luminescent component 11; when the connector area is in the conduction state, in addition to illuminating the entire transparent connector upper housing 4 and connector lower housing 2, the character pattern inverse decal 3 is simultaneously highlighted by the illumination.

Due to the structural principles of the invention herein, the entire connector can be fabricated as a non-transparent member, the luminescent component disposed inside the connector housing and the said luminescent component coupled to the power wires in the connector, with a character pattern formed into the surface of the said housing serving as a pellucid construct such that the light of the said luminescent component is emitted outward through the character pattern.

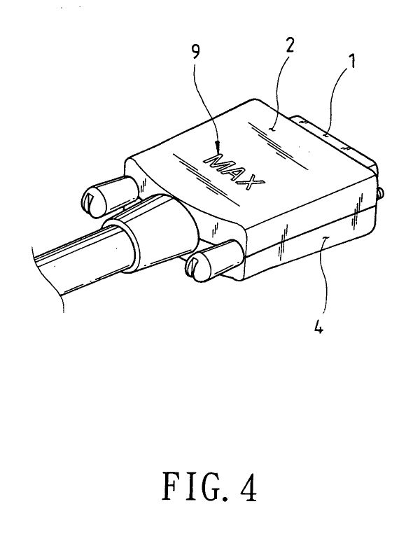

As indicated in FIG. 4, the entire plug is fabricated as a non-transparent connector upper housing 2 and connector lower housing 4, the luminescent component 11 disposed inside the connector housing and the said luminescent component 11 coupled to the power wires 7 and 12 in the connector, with the character pattern 9 showing on the surface of the said housing serving as a pellucid construct such that when the connector is in the conduction state, the character pattern 9 is simultaneously accented by the illumination.

In addition to the DVI plug shown in FIG. 1, FIG. 2, FIG. 3, and FIG. 4, the structure of the invention herein can be utilized in any connector plug having built-in power source capability, including USB plugs, IEEE1394 plugs, RJ-type power plugs, HDMI plugs, and SCART plugs.

1. A conduction state indicating connector in which the connector plug at the connector lower housing and the rear extent of the contact pins inside the connector upper housing are coupled to the power wires of a cable via the contact pin power leads of the said connector plug, with a luminescent component installed at the end such that when the said connector is in a conduction ready state, the said luminescent component glows through the transparent said connector upper housing and said connector lower housing, thereby illuminating the entire said connector.

2. As mentioned in claim 1 of the conduction state indicating connector of the invention herein, to adjust the magnitude of current supplied to the said luminescent component, a resistor of an appropriate size can be placed in series between the said power lead and the said luminescent component.

3. As mentioned in claim 1 of the conduction state indicating connector of the invention herein, the said luminescent component is an LED.

4. A conduction state indicating connector in which the said connector plug at the said connector lower housing and the rear extent of the contact pins inside the said connector upper housing are coupled to the said power wires of the said cable via the said contact pin power leads of the said connector plug, with the said luminescent component installed at the end; a character pattern inverse decal is affixed onto the said connector lower housing or the said connector upper housing and when the said connector is in a conduction ready state, the said luminescent component glows through a transparent said connector upper housing and said connector lower housing and, furthermore, in addition to illuminating the entire transparent said connector upper housing and said connector lower housing, the said character pattern inverse decal is simultaneously highlighted by the illumination.

5. A conduction state indicating connector in which the said connector plug at the said connector lower housing and the rear extent of the contact pins inside the said connector upper housing are coupled to the said power wires of the said cable via the said contact pin power leads of the said connector plug, with the said luminescent component installed at the end; a character pattern serving as a pellucid construct is formed in the surface of the said connector lower housing and the said connector upper housing such that when the said connector is in a conduction ready state, the light of the said luminescent component is emitted outward through the said character pattern.
